(19) United States
(12) Patent Application Publication
(10) Pub. No.: US 2005/0278552 A1
(43) Pub. Date: Dec. 15, 2005

(54) Secure virtual account

(76) Inventors: Vincent Delisle, Ottawa (CA); Tracy Carroll, Ottawa (CA)

Correspondence Address: TEITELBAUM & MACLEAN, 1187 BANK STREET, SUITE 201, OTTAWA, ON, K1S 3X7, CA

(21) Appl. No.: 10/865,979

(22) Filed: Jun. 14, 2004

(51) Int. Cl. G06F 11/30

(52) U.S. Cl. 713/193

(57) ABSTRACT

The invention relates to a method for storing data or a hierarchic folder structure on a selected number of computers and/or intelligent devices having storage capacity in a community of computers and/or intelligent devices, which are able to communicate with each other, wherein a portion of the storage capacity of each of the selected number of computers and/or intelligent devices is made available for sharing. The storage devices are chosen from the community based on file management attributes, device attributes, and corresponding statistical criteria. In another embodiment, the storage devices are partially chosen by the user.

### CROSS-REFERENCE TO RELATED APPLICATIONS

This application does not claim priority.

### TECHNICAL FIELD

The present invention relates to methods for secure file storage and retrieval in a distributed computer network.

### BACKGROUND OF THE INVENTION

Computers have become accessible to almost everyone. Their low cost and high productivity make them suitable for many personal and commercial applications. It is now common for an individual to have access to multiple computers, for example, at work, at home, and on vacation. Moreover, there are now a number of portable devices, such as laptops, electronic agendas, cell phones, multi-media players and cameras, which can also contain an individual user's electronic data.

With a user's data stored in multiple locations, it has become difficult to securely access, synchronize, backup and manage information. Maintaining consistency of user settings across platforms is also an issue.

The Internet has given a partial solution to the problem by making most computers accessible on a global communication network, but this accessibility raises a security concern. There is also no guarantee that the computer or intelligent device containing the required information will be turned on or connected to the network at any given time. Other concerns are permanent failures of storage devices, and the speed of communications networks.

Another noticeable phenomenon is that storage for personal computers has become so affordable that many users have significant amounts of unused storage capacity.

In the past, several techniques have been employed to solve these issues individually. In the workplace, data backup and accessibility are accomplished using a dedicated server, with data backup being done manually or automatically on a predetermined schedule. Some server systems, such as the system disclosed in U.S. Pat. No. 6,704,755 issued to Midgely et al. in March 2004, also automatically take care of data synchronization.

For personal computers, data backup is usually done manually by the individual user using tape drives or CD-ROMs; a task which is often forgotten or performed infrequently. This backup method does not solve the problem of universal data accessibility, and also leaves data vulnerable to theft or fire/water damage, since the original data and backup are often located in the same building. Some systems such as the one disclosed in U.S. Pat. No. 6,615,244, issued to Singhal in September 2003, solve this problem by making geographically remote backup servers available to users over the Internet, but this is not the most cost-effective solution due to the high cost of servers. It does not capitalize on the low-cost unused storage capacity of personal computers and portable devices.

Data transfer over the Internet has been made secure using various encryption algorithms, such as asynchronous and synchronous cryptography. However, the data is generally encrypted during transmission only, and is not always encrypted on the storage devices themselves. This leaves data vulnerable, especially data containing personal information.

A partial solution to these problems has been disclosed in U.S. patent application 2002/0188605, published in December 2002 by Adya et al., which describes a serverless distributed file system. This system makes use of the unused storage capacity on personal computers, by making a portion of each storage unit available for sharing with other users of the system, and automatically distributing encrypted file copies to remote locations. The number of remote copies within a given system of users is fixed using a Byzantine fault-tolerance equation. This is not the most efficient use of disk space, since high and low priority files will all have the same number of remote copies.

U.S. patent application 2003/0233455 published in December 2003 by Leber et al. also describes a distributed file system using peer-to-peer communication, however it relies on a server for the management functions of the system, which again is not the most cost effective solution.

Accordingly, there is a need in the art for a method of distributed file storage, which is both cost effective by not requiring the use of servers, and which uses available storage capacity efficiently.

### SUMMARY OF THE INVENTION

Accordingly, the present invention relates to a method for secure, cost effective, and efficient distributed file storage and retrieval. The invention, called ‘Secure Virtual Account’, proposes to distribute encrypted user files on a sufficient number of potentially unreliable and unsecured network-accessible computers or intelligent devices. The sufficient number of file replicas is determined independently for each file using statistical criteria based on file attributes set by the user and the characteristics of the remote storage media. The file attributes are related to the pre-determined priority or importance of the file, and can include, but are not limited to, the desired lifetime, accessibility, integrity, and/or privacy level. The remote storage media will be chosen based on device attributes such as, but not limited to, availability, access time, reliability, location, and/or user preference. A server is not necessary for this system to function, and by having flexibility in the number of file replicas, storage capacity can be used efficiently.

Another aspect of the present invention relates to security. To this end, files are encrypted before storage on the remote storage media. Each file is given a unique identification number, which is used in the filename, and which does not give any information about the file, providing a further level of security. A further security aspect of the invention uses a hash code or a check-sum to verify the integrity of the file contents, to prevent data, which has been corrupted or attacked by a virus from being opened.

Another feature of the present invention allows the user to have some control over the storage locations of the file replicas. In this embodiment, the user can choose any number of computers or intelligent devices on which a file must be stored, and the software will automatically choose additional computers if necessary. This feature allows the user to choose personally trusted storage locations if desired.

One embodiment of the invention users a portable hardware device to store any subset of: the user's encryption key, a unique number identifying the user, the user's root directory, and the software which implements the inventive method described herein.

### BRIEF DESCRIPTION OF THE DRAWINGS

The invention will be described in greater detail with reference to the accompanying drawings, which represent preferred embodiments thereof, wherein:

FIG. 1 depicts a communication network, with any number of accessible computers or intelligent devices, where each sets aside a portion of its storage capacity to be shared with other users, and an optional portable hardware key.

FIG. 2 is a flowchart depicting how data or a hierarchic folder structure is encrypted into a file that is distributed to remote computers or intelligent devices.

FIG. 3 depicts a representative statistical distribution for a device attribute, and how it relates to the storage criteria of a corresponding file management attribute.

FIG. 4 is a flowchart depicting the generation of file replicas in a loop process to satisfy the criteria of the management attribute by referencing a device attribute's statistical distribution.

FIG. 5 depicts the unique identification number when it partially identifies an individual user.

FIG. 6 depicts the selection of remote device targets for file replicas when the user can partially choose the remote storage devices.

### DETAILED DESCRIPTION

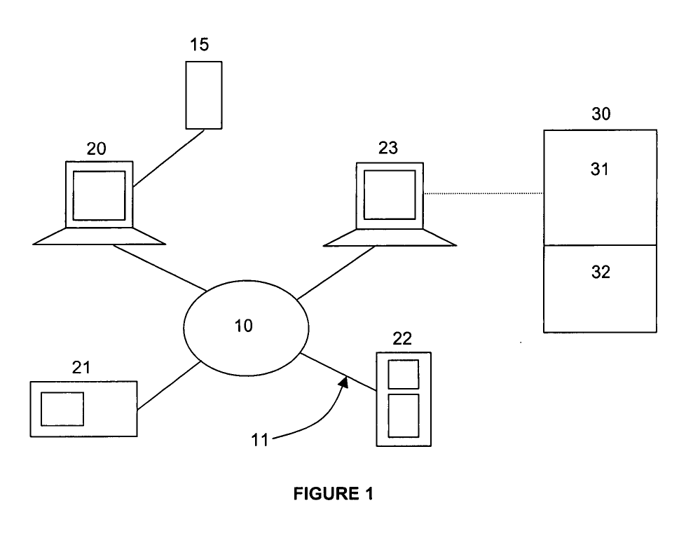

With reference to FIG. 1, computers or intelligent devices 20, 21, 22 and 23 make up members of a community for the distributed file storage and retrieval method described herein. Such a community is not limited to four members. The community members are connected to a communication network 10, through communication links 11. A portion of some, but not necessarily all, of the storage capacity 30 of the computers or intelligent devices in the geographically diverse community is made available for sharing with other users, so that the full storage capacity 30 is divided into two sections; a private section 31, and a shared section 32. Each community member can decide to share any amount of storage capacity, from none to all of the capacity. A portable hardware device 15 can be provided for reasons that will be discussed later in this detailed description.

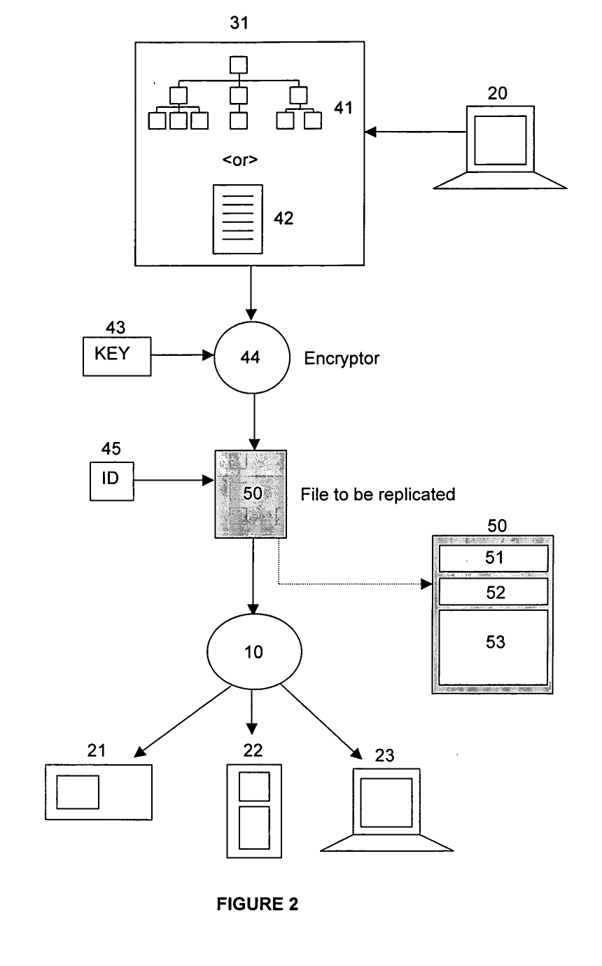

FIG. 2 depicts the creation of an encrypted file 50 which is to be remotely stored. A representative user computer or intelligent device 20 will contain in its private memory 31 a hierarchical folder structure 41 containing a number of data files, for example, file 42. The hierarchical folder structure is encrypted and stored independently of the data files that it contains. The hierarchical folder structure 41 or data file 42 is encrypted by means of an encryption method 44, using a private user key 43. The preferred embodiment uses symmetric cryptography for the encryption method. Each hierarchical folder structure 41 or data file 42 is associated with a unique identification number, which is created by number generator 45. The unique identification number is used in the filename for the encrypted file 50, and subsequently all remote file replicas of 50. In the preferred embodiment, this unique identification number is a random number, generated using a true random generator, and is at least 128 bits in length. This will ensure that no two files have conflicting file names, and also ensure that no information about the file can be learned from the file name.

Each encrypted file 50 contains at least three parts: the filename 51, which is made up at least in part of the unique identification number; at least one management attribute 52 related to the user-determined importance or priority level of the encrypted file; and the encrypted data or hierarchical file structure 53. The encrypted file can also contain descriptive file attributes such as keywords, but these are not used in the determination of number and location of remote file replicas. This encrypted file 50 will be distributed to remote storage devices 21, 22 and 23, or more, not shown. There is no inherent upper or lower limit to the number of generated file replicas.

The management attributes can be a combination of the expected lifetime of the file, the expected accessibility level of the file, the expected integrity of the file (i.e., how important it is that the file never be corrupted), the required privacy of the file or some other attribute related to the user-determined importance or priority level of the file. The invention described herein will implement default values for the management attribute(s), can implement hierarchically inherited values through the user's hierarchic folder structure, or the user can change the default or inherited value independently for each file. In one embodiment of the invention, the management attribute is also encrypted, to prevent targeted attacks on high-priority files.

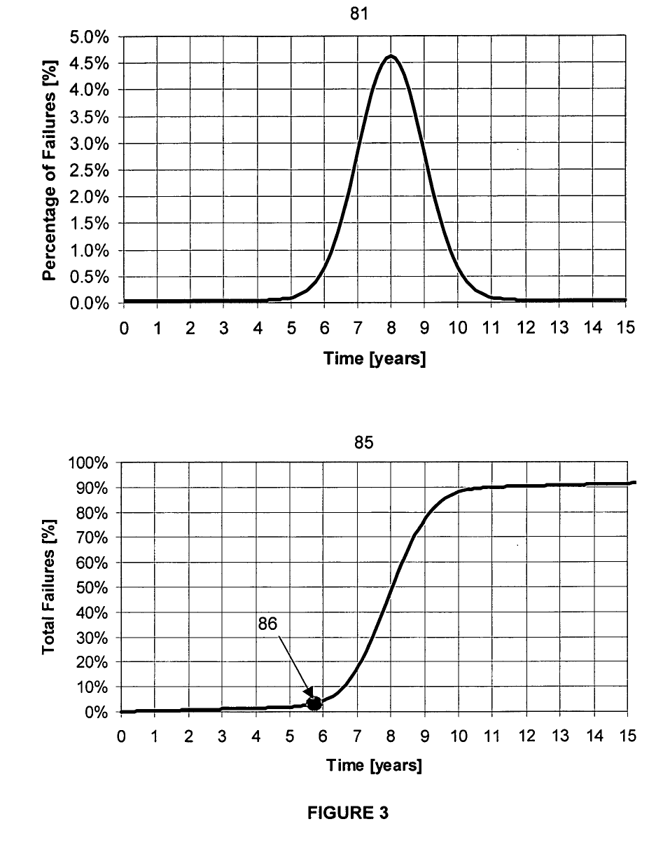

Each computer or intelligent device in the community of storage devices, 20 through 23, will have a device attribute associated with it; the device attribute can be the expected failure rate of the community member, the expected up-time of the community member, the typical access time of the community member, the geographical location of the community member, or some other attribute related to the community member's storage capacity and communication link. FIG. 3 depicts one example of a device attribute statistical distribution. In the preferred embodiment, the statistical distribution of the device attribute is approximated by a Gaussian function. Distribution 81 shows the expected failure rate versus age of a representative storage device. Distribution 85 is the integral of 81, depicting the total expected failures over time. If file 50 were stored on this device, its expected lifetime can be defined, for example, as the number of years that have passed when the total number of failures on that storage device reaches 3%, indicated by point 86 in FIG. 3. An encrypted file stored on this device could expect to have a lifetime of approximately 5.75 years.

Alternately, if the device attribute of interest is the up-time of the storage device, the statistical curve might show the probability throughout a representative day that the storage device will be available; i.e. turned on and connected to the network. The up-time distribution could be a Gaussian function similar to that in FIG. 3, defined by the mean and standard distribution of hours a community member is typically available to be accessed. For example, a PC might have an up-time of8 hours±3 hours, and a laptop might have an up-time of 2 hours±1 hour. In one embodiment, the expected accessibility level for a file stored on a device with a given up-time distribution is extracted from the total up-time distribution at the 3-sigma point, in the same manner that the expected lifetime is extracted from the failure distribution in FIG. 3 as described herein.

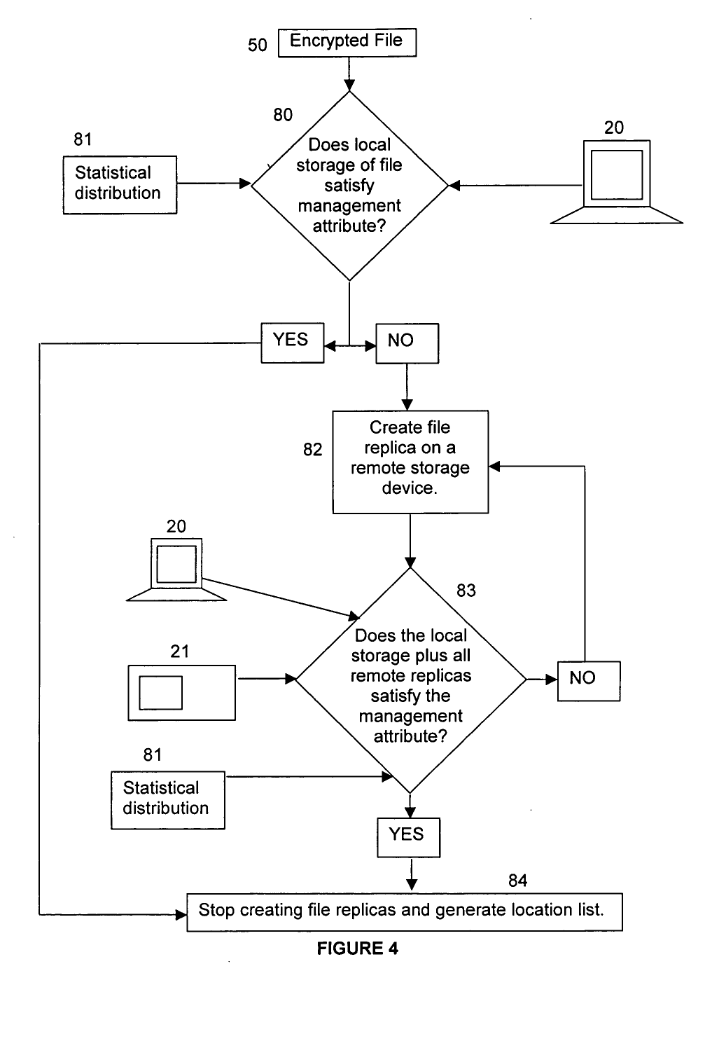

FIG. 4 is a flowchart outlining the method for generating remote file replicas of the encrypted file 50. The number of generated replicas is not a constant, such as the constant number determined in a Byzantine fault-tolerant system as described in Adya et al., but instead is determined independently for each encrypted file. If, for example, the user's local computer is device 20, which has at least one associated device attribute statistical distribution, the first step in the replica generation process will be to determine if local storage of the file is enough to satisfy the requirements of the management attribute. If the criteria of the management attribute is satisfied locally, no remote storage is necessary. If not, then file replicas are generated in a loop; after each replica is generated, a check 83 is made to see if the management attribute criteria has been satisfied by the addition of a new storage device, e.g. 21, by referencing its corresponding device attribute statistical distribution. With each additional replica, the expected lifetime, accessibility, integrity, privacy level, or other management criteria increases according to the device attribute of the new storage device. For example, if a file's management attribute is its expected lifetime, and the desired lifetime of that file is 7.5 years, then it would need to be stored on 3 storage devices with failure distribution 81 to meet a 97% confidence level that at least one of the 3 storage devices will still be functional in 7.5 years. When combining multiple devices, the statistical distributions are multiplied together to get the resulting distribution for the combination of all of the storage devices.

In one embodiment, once enough replicas are generated, a location list, 84, is generated for each file, documenting on which computers and/or intelligent devices the file has been stored. The location list can be stored as an additional management attribute of the file, or in a global database, but is not restricted to these examples. In one embodiment of the invention, the file is also compressed before being remotely stored for further efficiency in storage capacity use.

File retrieval is accomplished by sending requests, including the unique identification number of the file, to the devices in the location list. If the file is not available on any of the devices in the location list because it has been deleted, corrupted, or the storage devices are not available, or if a location list was never generated, then a second set of requests is broadcast to all the devices in the community of computers and intelligent devices. Decrypting the file replica is also performed in the retrieval phase. One embodiment of the inventive method adds the step of designating a recovery authority, which can decrypt the file in case a user's decryption information is lost. The information, about the recovery authority, is included as a file attribute. In this case, each file would be encrypted with its own secret key. The secret key will be wrapped by the private key of the file's owner, the recovery authority, or anyone else given access to the file. The wrapped keys will also be saved as file attributes. Another embodiment of the present invention includes the step of storing a hash code or check-sum of the data or hierarchical folder structure with the encrypted file, and using the hash code or check-sum to verify the integrity of the file before it is retrieved.

In a typical hierarchical folder structure, each folder can contain files or sub-folders. In one embodiment of the proposed inventive method, folders can also contain data objects, which are not serialized in their own file. When encrypted and distributed to remote storage devices, these data objects will be serialized together with the folder structure that references them. Therefore, they do not require their own unique identification number.

The root folder in a hierarchical folder structure will by default be given the highest management attribute level, for example, the longest possible lifetime or highest accessibility level, to ensure that the user will always have access to its latest revision. Having the latest revision of the root folder, the user will have access to the latest unique identification numbers of all the files or sub-folders in the hierarchical folder structure. That will ensure that the user will always access the most recent revision of any file. The user will be notified if the most recent revision is not accessible during the retrieval phase, and prompted to decide whether to open an older revision. This is how the inventive method disclosed herein takes care of file synchronization.

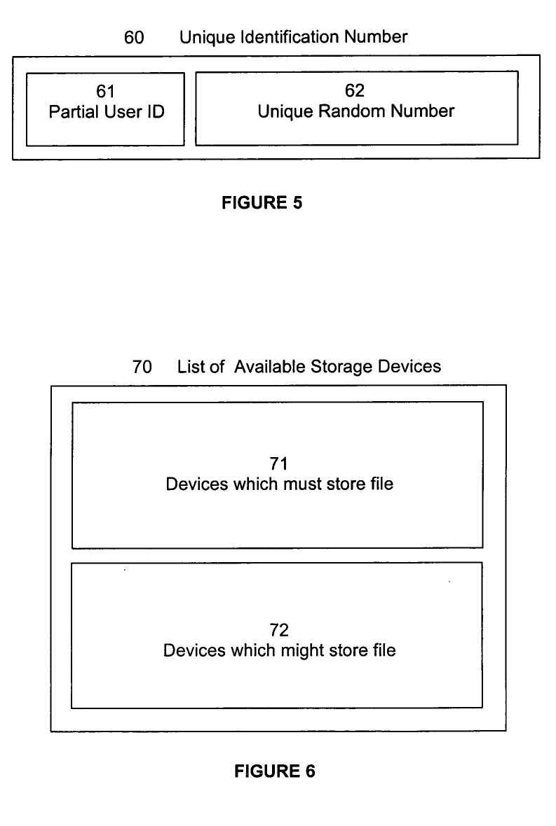

With reference to FIG. 5, in one embodiment of the invention, the unique identification number 60 contains at least 2 and no more than 64 bits that partially identify an individual user, 61. The remaining bits 62 are a randomly generated number. This will increase the speed of file retrieval in the case where a community-wide search for the file must be performed; for example, if a file's location list is corrupted.

With reference to FIG. 6, in another embodiment of the present invention, the user is given the option to designate a subset of the storage devices in the community of computers or intelligent devices on which a file must be stored. The entire list of available storage devices 70 is divided into two parts; devices on which the file must be stored 71, and devices on which the file might be stored 72, if additional storage locations are necessary to satisfy the management attribute using the statistical criteria, as in FIG. 4.

With reference to FIG. 1, in one embodiment of the invention, the private key used to encrypt and decrypt the files is stored on a portable hardware device 15. This allows the user to access their files from any computer on which the software, which implements the present method, is available. In another embodiment, the software is also installed on the portable hardware device 15. In another embodiment, a global user identification number for the user is stored on the portable hardware device 15.

In another embodiment of the invention, selected files are stored on a portable hardware device 15, to ensure synchronization of the file replicas to the files on the portable hardware device. The files on device 15 are assumed to be the most up-to-date versions of those files, and the software will automatically update all remote file replicas to synchronize with the version stored on the portable hardware device 15.

1. A method for storing data or a hierarchic folder structure on a selected number of computers and/or intelligent devices having storage capacity in a community of computers and/or intelligent devices, which are able to communicate with each other, wherein a portion of the storage capacity of each of the selected number of computers and/or intelligent devices is made available for sharing, comprising the steps of:
(a) encrypting the data or the hierarchic folder structure into a file;
(b) associating a management attribute, based on a pre-determined importance of the file, with the file;
(c) associating a device attribute, based on a pre-determined characteristic of the storage device, with each community member; and
(d) storing the file on the selected number of computers and/or intelligent devices, wherein the selected number of computers and/or intelligent devices is identified based on a statistical distribution, which correlates the management attribute of the file and the device attribute of the community members.

2. The method of claim 1, further comprising the steps of:
(e) associating each file with a unique identification number, following step (a);
(f) generating a location list of the selected number of computers and/or intelligent devices on which the file has been stored; and
(g) retrieving a replica of the file by referencing the unique identification number and the location list.
(h) decrypting the file replica.

3. The method as defined in claim 2, further comprising the step of designating a recovery authority, which can decrypt the file in case a user's decryption information is lost; wherein information, about the recovery authority, is included as a file attribute.

4. The method as defined in claim 1, further comprising the step of encrypting the management attribute.

5. The method as defined in claim 1, wherein the hierarchic folder structure can contain data objects not referenced by a unique identification number.

6. The method as defined in claim 1, wherein the management attribute is selected from the group consisting of an expected lifetime of the file, an expected accessibility of the file, an expected integrity of the file, and a required privacy level of the file.

7. The method as defined in claim 1, wherein the device attribute is selected from the group consisting of a failure rate distribution of the community member, an up-time distribution of the community member, an access time distribution of the community member, or another distribution related to a characteristic of the storage device.

8. The method as defined in claim 1, wherein the statistical distribution of the device attribute is approximated by a Gaussian function.

9. The method as defined in claim 1, further comprising the step of compressing the data, before step (a).

10. The method as defined in claim 2, wherein the unique identification number is generated with at least 128 random bits.

11. The method as defined in claim 2, wherein the unique identification number contains at least 2 and no more than 64 bits that partially identify an individual user.

12. The method as defined in claim 2, further comprising the step of using a hash code or a cyclic redundancy check code to ensure the data integrity.

13. A method for storing data or a hierarchic folder structure on a plurality of computers and/or intelligent devices with storage capacity in a community of computers and/or intelligent devices, which are able to communicate with each other, wherein a portion of the storage capacity of each of the plurality of the community members is made available for sharing with a subset of community members, comprising the steps of:
(a) encrypting the data or the hierarchic folder structure into a file;
(b) associating a management attribute based on a pre-determined importance of the file with each file;
(c) associating a device attribute based on a pre-determined characteristic of the storage device with each community member;
(d) dividing the community membership into two lists: the first list includes community members on which the file must be stored, the second list includes community members on which the file might be stored, if necessary to satisfy the management attribute;
(e) storing the file on each of the computers or intelligent devices within the first list; and
(f) storing the file on a plurality of computers or intelligent devices within the second list, wherein the selected number of computers and/or intelligent devices in the second list is identified based on a statistical distribution, which correlates the management attribute of the file and the device attribute of the community members.

14. The method as defined in claim 13, further comprising the steps of:
(g) associating each file with a unique identification number, following step (a);
(h) generating a location list of community members on which the file has been stored;
(i) retrieving a replica of the file by referencing the unique identification number and the location list; and
(j) decrypting the file replica.

15. The method as defined in claim 14, further comprising the step of designating a recovery authority, which can decrypt the file in case a user's decryption information is lost; wherein information, about the recovery authority, is included as a file attribute.

16. The method as defined in claim 13, further comprising the step of encrypting the management attribute.

17. The method as defined in claim 13, wherein the hierarchic folder structure can contain data not referenced by a unique identification number.

18. The method as defined in claim 13, wherein the management attribute is selected from the group consisting of an expected lifetime of the file, an expected accessibility of the file, an expected integrity of the file, and a required privacy level of the file.

19. The method as defined in claim 13, where the device attribute is selected from the group consisting of a failure rate distribution of the community member, an up-time distribution of the community member, an access time distribution of the community member, or another distribution related to a characteristic of the storage device.

20. The method as defined in claim 13, further comprising the step of compressing the data before step (a).

21. The method as defined in claim 14, where the unique identification number is generated with at least 128 random bits.

22. The method as defined in claim 14, where the unique identification number contains at least 2 and no more than 64 bits that partially identify an individual user.

23. The method as defined in claim 14, further comprising the step of using a hash code or a cyclic redundancy check code to ensure the data integrity.

24. The method as defined in claim 1, further comprising the step of storing a private encryption key for decrypting the file and a global user identification number of the user on a portable hardware device.

25. The method as defined in claim 24, wherein selected files are stored on the portable hardware device, to ensure synchronization of file replicas to the data on the portable hardware device.

26. The method as defined in claim 24, wherein management software for implementing steps (a) to (h) is stored on the portable hardware device.
